(19) United States
(12) Patent Application Publication
(10) Pub. No.: US 2023/0010355 A1
(43) Pub. Date: Jan. 12, 2023

(54) REAL ESTATE FUND TRANSFER FACILITATION SYSTEM

(71) Applicant: Legal IP Tech, LLC, West Palm Beach, FL (US)

(72) Inventor: James N. Brown, West Palm Beach, FL (US)

(73) Assignee: Legal IP Tech, LLC, West Palm Beach, FL (US)

(21) Appl. No.: 17/860,455

(22) Filed: Jul. 8, 2022

Related U.S. Application Data
(60) Provisional application No. 63/219,619, filed on Jul. 8, 2021.

(51) Int. Cl. G06Q 20/10; G06Q 50/16

(52) U.S. Cl. CPC G06Q 20/108; G06Q 50/163

(57) ABSTRACT

A real estate fund transfer facilitation system may include a digital platform for receiving requests to facilitate real estate fund transfers for deposit in accounts of a title company. An intake module may be configured to marshal a depositing party through a workflow to collect transaction information. A portal may be provided that includes a selectable link for accessing the intake module. An output module may be configured to output transaction instructions with respect to preparation of a financial instrument as a vehicle for the deposit of the real estate funds in the receiver account.

### CROSS-REFERENCE TO RELATED APPLICATIONS

This application claims priority to U.S. Provisional Application No. 63/219,619, filed Jul. 8, 2021, which is incorporated herein by reference in its entirety.

### FIELD OF TECHNOLOGY

The present disclosure is directed to facilitating real estate fund transfers and, more specifically, facilitating secure transfer of deposit monies from real estate buyers to title companies.

### BACKGROUND

Historically, realtors or title companies email wire instructions to buyers. Buyers then follow the instructions to wire the money to the title companies. This process, however, is wrought with cyber fraud exposure to realtors as well as title agents. Realtors also frequently fail to provide complete wire instructions to buyers. Even when complete wire instructions are provided, buyers frequently fail to follow the wire instructions and tend to leave out important information that title companies use to match and allocate the wired funds. Relatedly, title companies often receive naked wires that fail to identify a contract or parties, making it difficult and time consuming to match the deposit and allocate it to the corrected parties and property.

What is needed are improved real estate wire transfer systems and methods.

### SUMMARY

In one aspect, a real estate fund transfer facilitation system may include a digital platform for receiving a request to facilitate a real estate fund deposit from a depositing party to a receiving party. The receiving party may be a title company or title agent. The digital platform may include an intake module, a portal to the intake module, and an output module. The intake module may be configured to marshal the depositing party through a workflow to collect transaction information and to define a transfer of the funds for deposit in a receiver account of the receiving party using at least a portion of the collected transaction information. The portal may include a selectable link for accessing the intake module. The output module may be configured to output transaction instructions with respect to preparation of a financial instrument as a vehicle for the transfer of the real estate funds in the receiver account.

In one embodiment, the output instructions include one or more absent or incomplete pieces of information. The depositing party may be required to call a system administrator or the receiving party to obtain the absent or complete information. In one example, the absent or incomplete pieces of information comprises an account number for the receiver account.

In one embodiment, the financial instrument is a wire transfer and the transaction instructions include a notation to be included in a reference line associated with the wire transfer. In one example, the notation includes an address of the subject property or a reference to a sales contract.

In one embodiment, the portal comprises a selectable link. In one example, selecting the selectable link for the portal is the only way a depositing party may access the intake module.

In one embodiment, the intake module is configured to query the depositing party for a type of financial instrument for which the depositing party is requesting the output module to output instructions.

In various embodiments, the transaction information includes a name of a real estate agent associated with the transaction or an address of a subject real estate property.

In one embodiment, the system further includes a user account module configured to maintain user accounts for parties associated with the transaction. In one example, when the output module outputs transaction instructions, the output module posts a transaction log to user accounts of the parties associated with the transaction selected from a real estate agent or the receiving party.

In another aspect, a method of facilitating a real estate fund transfer includes: receiving a request to facilitate a real estate fund deposit from a depositing party to a receiving party comprising a title company or title agent; marshaling the depositing party through a workflow to collect transaction information and define the transfer of funds for deposit in a receiver account of the receiving party using at least a portion of the collected transaction information; providing a selectable link to the workflow; and outputting transaction instructions with respect to preparation of a financial instrument as a vehicle for the transfer of the real estate kinds in the receiver account.

In one embodiment, the output instructions include one or more absent or incomplete pieces of information, and the depositing party is required to call a system administrator or the receiving party to obtain the absent or complete information. In one example, the one or more absent or incomplete pieces of information comprises an account number for the receiver account.

In one embodiment, the financial instrument is a wire transfer and the transaction instructions include a notation to be included in a reference line associated with the wire transfer selected from an address of the subject property or a reference to a sales contract. In one example, selecting the selectable link for the portal is the only way a depositing party may access the intake module.

In one embodiment, the method further includes: maintaining user accounts for parties associated with the transaction; generating a transaction log with respect to transaction instructions output to depositing parties; and posting events related to the transaction to user accounts of parties associated with the transaction. In one example, the method further includes: receiving a transaction update that funds subject to the deposit have been deposited in the receiver account; and posting the update in user accounts of parties associated with the transaction.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 is a schematic of a fund transfer facilitation system according to various embodiments described herein;

FIG. 2 is an interface of a digital platform for facilitating real estate fund transfers including a portal according to various embodiments described herein;

FIG. 3 is an interface of a digital platform for facilitating real estate fund transfers according to various embodiments described herein;

FIG. 4 is an intake module interface for facilitating real estate fund transfers according to various embodiments described herein;

FIG. 5 is an intake module interface for facilitating real estate fund transfers according to various embodiments described herein;

FIG. 6 is an intake module interface for facilitating real estate fund transfers according to various embodiments described herein;

FIG. 7 is an intake module interface for facilitating real estate fund transfers according to various embodiments described herein;

FIG. 8 is an intake module interface for facilitating real estate fund transfers according to various embodiments described herein;

FIG. 9 illustrates wire instructions output by an output module for facilitating real estate fund transfers according to various embodiments described herein;

FIG. 10 illustrates check delivery instructions output by an output module for facilitating real estate fund transfers according to various embodiments described herein; and

FIG. 11 is a schematic of a computer apparatus for executing operations of a fund transfer facilitation system according to various embodiments described herein.

### DESCRIPTION

Parties to real estate transactions require secure fund transfers. According to various embodiments, a secure transfer of real estate funds between real estate parties and a receiving party, such as a title company or real estate broker, includes utilizing the fund transfer facilitation systems or processes described herein to securely effectuate fund transfers. The transaction may be between a depositing party and a receiving party that is facilitated by the system. The system may be operated by a facilitator, which in some instances may also be the receiving party.

The depositing party will typically be a party to a real estate transaction such as a buyer, seller, lessee, or lessor. However, in some instances the depositing party may not be a party to the real estate transaction, but may be depositing funds on behalf of a party to the transaction.

In various embodiments, the fund transfer facilitation system may be operated by a facilitator that includes a title company or real estate broker. In one example, the system is operated by a facilitator selected from a title company, real estate broker, or other party authorized to receive the fund transfer and is, thus, also the receiving party. The transfers of funds facilitated by the system may be deposited into a receiver account, such as a trust account, escrow account, or other account, which may be specified by contract or law applicable to the character of the transfer and parties involved. The receiving party will typically be bound by law to hold funds in trust and to release funds according to a contract, party intentions, law, and/or local custom.

In various embodiments, the fund transfer facilitation systems and processes may be operated or performed, at least in part, by a facilitator that is a title company, which may or may not be engaged to perform title services with respect to the real estate transaction. However, in other embodiments, the fund transfer facilitation systems and processes may be operated or performed by a facilitator that is not a title company and which may or may not be involved in the real estate transaction. For example, the facilitator may be a real estate broker or commercial system administrator. In some embodiments, the facilitator includes a first title company or broker that facilitates at least a portion of the transfer process and acts as a middleman or routing agent for a second title company or broker as the receiving party.

In some embodiments, the fund transfer facilitation system operates on behalf of a facilitator selected from a title company, real estate broker, or other party that operates as a property manager to collect rent on behalf of a landlord. In some instances, the facilitator may be the receiving party and funds may be deposited into an account held for the benefit of the landlord or the landlord ay be the receiving party and the funds may be deposited into an account of the landlord.

The character of the fund transfers facilitated by the fund transfer facilitation system may include, but are not limited to, rent, earnest money pursuant to a sale and/or purchase contract, settlement, closing funds, deposits, dues, or assessments.

The fund transfer facilitation systems and processes may facilitate one or more types of fund transfers. For example, the system may facilitate fund transfers using various financial instruments or transfer vehicles, such as one or more of a check, a money order, a cashier's check, a bank draft, a traveler's check, a wire transfer, an electronic fund transfer, or the like.

In some implementations, the fund transfer facilitation systems and processes may be configured to remove real estate agents out of the exposure loop, and help solve the exposure issue for title agents. For example, the fund transfer facilitation system and processes may direct fund transfer from the depositing party directly into an account of the receiving party. Thus, real estate agents will not be exposed due to failure to properly hold or deliver funds to a real estate brokers or title company. Title agents or companies will be assured sufficient identifying information is linked to the funds. In some instances, the funds may be deposited directly into a trust or escrow account by the depositing party or a fund transfer resource on behalf of the depositing party.

The fund transfer facilitation system may include software comprising instructions that when executed by a processor perform operations of the fund transfer facilitation system. The fund transfer facilitation system may include, incorporate, and/or operate on computers, servers, mainframes, or the like and may include processors configured to process instructions and data, memory for storing instructions and data, and communication ports, such as modems for receiving deposit requests, transmitting deposit instructions or webpage data, and other fund transfer facilitation system communications. In various embodiments, the system may be accessible via a public or private network. The system may be configured to provide a user interface accessible to depositing parties. The interface may include an application, program, web app, webpage, or the like. A user, such as a depositing party, receiving party, or real estate agent, may interface with the system via an electronic device such as a personal computer, laptop, tablet, smart phone, or other network enabled device.

The fund transfer facilitation system may collect data from the user in an intake phase and then, in an output phase, generate transfer instructions bases at least in part on the collected data. Generation of the transfer instructions may be automatic. In some embodiments, the interface may include a portal that depositing parties may be directed to for simple entry into the intake phase of the facilitation process. For example, the intake phase may be accessed by selecting a portal comprising a button, icon, or tab on a webpage.

In the intake phase, the fund transfer facilitation system interfaces with the user to define the desired transfer in order to generate transfer instructions and/or effectuate the transfer in the output phase. For instance, the user may be queried by the system to provide information such as type of transfer, party identification, character of transfer, subject property, and/or associated parties, e.g., real estate agents.

In the output phase, the fund transfer facilitation systems may output instructions to the user that the depositing party is to follow to complete the transfer. The instructions may specify a receiver account into which the funds are to be deposited. The instructions may also include one or more notations to include on the financial instrument or associated therewith. The instructions may specify a location to deliver the financial instrument, such as to the facilitator, receiving party, or a bank/credit union or other entity that maintains the receiver account.

The depositing party may follow the instructions with respect to preparation of a financial instrument as the vehicle for the fund transfer or otherwise present the instructions to the funding resource to guide the preparation of the financial instrument. In some embodiments, funding from a depositing party's account may include utilizing an electronic fund transfer platform to transfer funds. Electronic fund transfer platforms may be integrated with the fund transfer facilitation system and/or operated by the facilitator or comprise a third party application platform such as Dwolla, Zelle, Apple Pay, Google Pay, PayPal, or Venmo. Electronic fund transfer platforms may also include bank/credit union, credit card, credit agency, or other fund transfer resources with available electronic fund transfer protocols.

The fund transfer facilitation system may generate a log that may be used to associate the eventual deposit with the transfer data and provide notice of the proposed deposit. The log may include information obtained or generated during the intake phase and/or included in the output. Thus, when the deposit occurs, the receiving party may be able to properly associate the deposit with the depositing party using the transaction details provided in the log. Additional information gathered during the intake phase, such as associated parties and property addresses, may be used to further ensure the deposit is properly tracked and allocated. The log or associated transaction details may be automatically transmitted to one or more named or associated parties to the transaction. The transmission may include an email, notification in an application, pop-up, account posting, or the like. For example, when the facilitating party is not the receiving party, a log of the transaction or associated details may be transmitted to the receiving party. In some embodiments, the system may provide updates of the progress of the transfer and deposition, such as when the instructions have been output and when the deposit has been completed.

In some embodiments, parties and/or associated parties may establish user accounts with the fund transfer facilitation system. The user accounts may include access to owned or associated transactions in which the user is named as either a depositing party, receiving party, or associated party, such as a real estate agent. Transaction logs may be posted to user accounts to allow the account holders to track progress of transactions. In one configuration, user accounts may include digital messaging allowing account holders to communicate among each other and exchange information such as transaction requests, party details, or updates, greatly improving ease, speed, and efficiency of transactions.

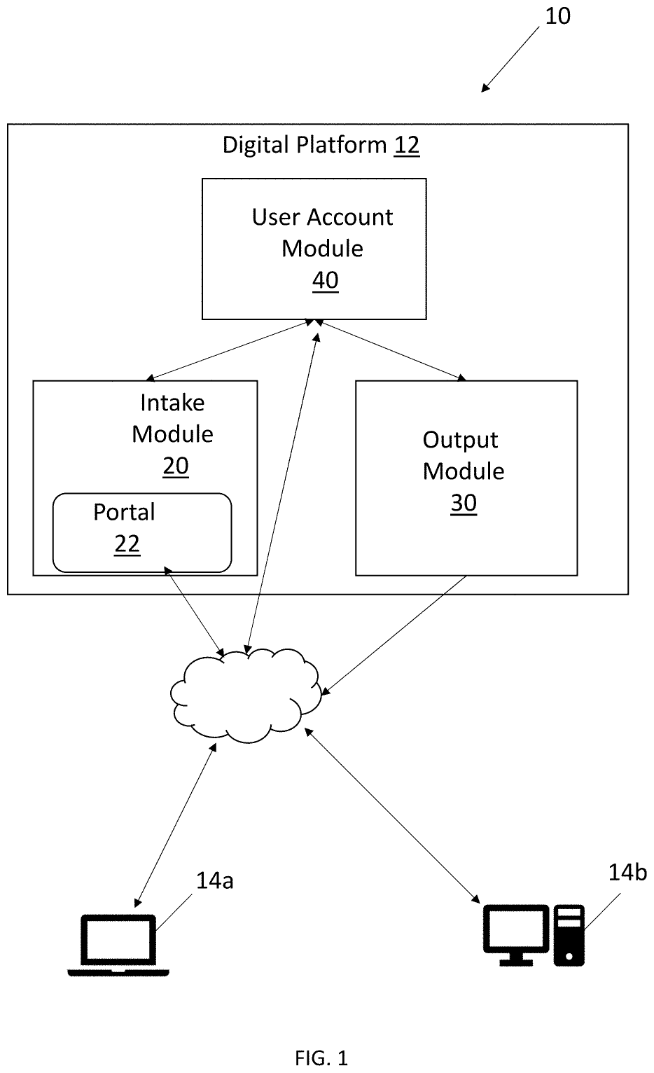

With reference to FIG. 1, the fund transfer facilitation system 10 may include a digital platform 12 for facilitating transfer and deposit of real estate fluids. In various embodiments, the digital platform 12 may be accessed via an internet connection by a user using a user device 14a, 14b that is internet enabled, such as a computer, tablet, laptop, or smart phone. The digital platform 12 may include software comprising instructions that when executed by a processor perform the operations of the digital platform 12. In one embodiment, the digital platform 12 may be executed, at least in part, on a server, such as a web server or application server. The server may include a processor and memory. The memory may store instructions that when executed by the processor causes the server to perform the operations of the fund transfer facilitation system 10 and digital platform 12. The digital platform 12 may include a communication port configured for direct or indirect electronic communication with user devices 14a, 14b and/or other network devices, such as with fund transfer resources.

The digital platform 12 may comprise or be configured to generate one or more webpages, a website comprising one or more webpages, and/or an application or program for execution on a user device 14a, 14b. The digital platform 12 may include a user side application through which a depositing party, receiving party, or other user may interface with the operations of the digital platform 12. The application may be stored remotely or locally with respect to the user device 14a, 14b.

The digital platform 12 may include an intake module 20 for processing workflows. In some embodiments, the digital platform 12 may include a portal 22 accessible via a public or private network by the user device 14a, 14b, which will typically be a user device 14a used by a depositing party. The portal 22 may provide access to the intake module 20 and associated workflow. For example, the depositing party may access the intake module 20 by accessing a portal page, such as a webpage, and/or utilizing an application program interface via the electronic device 14a. The portal 22 may comprise a link or address to the workflow of the intake module 20. For example, at the portal 22 the depositing party may be presented with an interface icon, button, or tab that the depositing party may click or otherwise select to indicate a desire to access the intake module 20 and/or other functionalities of the digital platform 12 to facilitate the transfer of funds. Once the depositing party has accessed the intake module 20, the depositing party may be presented with the workflow to facilitate the transaction.

The intake module 20 may marshal depositing parties through the workflow to define the transaction and generate customized transaction instructions. For example, the intake module 20 may be configured to query depositing parties for information the digital platform 12 will use to facilitate the transaction, such as by generating transaction instructions that the depositing party is to follow. In one example, the intake module 20 transmits selectable options to the user device 14a of a depositing party regarding the desired transfer. Through the input of data and/or selection of options, the intake module 20 directs the depositing party through the appropriate workflow while collecting data related to the desired transfer. The intake module 20 may interface with the depositing party via webpages incorporating data request, which may include selectable options, form fields, lists, or the like that the depositing party may select to specify the character of the desired transaction and the financial instrument to be used. It should be noted that while the digital platform 12 is described as being equipped to facilitate a number of different types of transfers to a number of different receiving parties, the fund transfer facilitation system 10 may be configured to facilitate any combination of transfer types and categories of transfer vehicles to any number of receiving parties including fewer or additional types, categories, or receiving parties. Thus, the number of options presented to depositing parties and the information collected in order to specify the transfer may differ between different implementations of the digital platform 12. For example, when only real estate purchases or sales are included, the intake module 20 may not interface with the user regarding rental or lease options.

In some embodiments, options may be presented sequentially such that selection of an option or specification of a transaction detail directs the user to follow-up options or fields appropriate for information already selected or specified. For example, the intake module 20 may interface with the depositing party to determine the character of the transfer, such as a purchase or sale, rental or lease, condominium or homeowner association or membership organization. Upon selection of a rental or lease, for example, the intake module 20 may automatically present the depositing party with one or more options to identify the desired receiving party, which may be provided in a list of receiving parties having an account or relationship with the digital platform 12 or facilitator and that are involved in receiving rent or lease payments, security deposits, or the like. Similarly, selection of condominium or homeowner association or membership organization may cause the intake module 20 to transmit a list of selectable receiving parties involved in receiving homeowner association dues, membership dues, or assessments.

Additionally or alternatively, the intake module 20 may present a list of static questions that the depositing party may answer or form fields that the depositing party may fill in to define the desired transaction. The intake module 20 may use the information gathered, at least in part, to generate custom transfer instructions, which may be automatic. In one embodiment, defining the transfer includes collecting information regarding one or more of the parties, associated parties, subject property, deposit amount, or deposit type. Example, deposit types for a sale or purchase may include first deposit, additional deposit, cash to close. An example deposit type may include an earnest money deposit. Deposit type for lease or rent may similarly include first deposit, second deposit, cash to close. In one example, deposition type for lease or rent may include one or more of rent, security deposit, utility deposit, pet deposit, or other.

In one embodiment, the intake module 20 interfaces with the depositing party to obtain identifying information of the depositing party, such as name, contact information, and/or address. The intake module 20 may further interface with the depositing party to specify the transfer details that define the transaction. For example, the intake module 20 may interface with the depositing party via the user device 14a to specify a deposit amount, deposit type, and address of the subject property. If one or more real estate agents are associated with the transaction, the depositing party may specify the names and/or contact information of the one or more agents. As explained in more detail below, the fund transfer facilitation system 10 may be configured to automatically associate this information with the transfer, which avoids the common issue of naked transfers that cause confusion and issues reconciling trust or escrow accounts. The digital platform 12 may also log interactions with the digital platform 12 and generate output logs that parties and/or associated parties identified in transactions may use to track the existence and/or progress of the transactions.

The digital platform 12 may also include an output module 30 for outputting transfer instructions with respect to facilitating and/or effectuating the transfer and deposit of the funds. As introduced above and described in more detail below, the instructions output may be provided to the depositing party for completion of the transfer resulting in the deposit. In some embodiments, the output module 30 may also integrate with an electronic fund transfer platform to effectuate electronic fund transfers.

As introduced above, the intake module 20 may be configured to guide the depositing pa through a workflow that leads to facilitation of the fund transfer for deposit into the receiver account. In various embodiments, the output module 30 may be configured to output instructions to the depositing party that the depositing party is to follow to complete the transfer. The depositing party may follow the instructions with respect to preparation of a financial instrument as the vehicle for the fund transfer or otherwise present the instructions to the funding resource to guide the preparation of the financial instrument.

In various embodiments, instructions output by the output module 30 for a wire transfer may specify the name of a bank maintaining the receiver account, a routing number, and name of the receiver account that is to receive the wire. Additional information in the output instructions may include the address of the bank and/or swift/BIC code. In a further example, the instructions may specify information to be included in the reference line. Such information may be used to promote subsequent identification of the transfers following deposit. For example, the instructions may request that an address of the subject property and/or the type of transaction, such as sale or lease, be included in the reference line. For checks, the instructions may specify the party or entity to which the check is to be made payable to, such as the receiving party. The instructions may specify an address to which the check is to be delivered to. The instructions may also specify a memo to include in the memo line. For example, the instructions may request that an address of the subject property and/or the type of transaction, such as sale or lease, be included in the reference line. In some embodiments, the output module 30 may output instructions for both a wire transfer and check delivery and the depositing party may choose which instrument they will use.

Additionally or alternatively, the output module 30 may be configured to communicate with, provide transfer instructions, and/or direct fund transfers from one or more fund transfer resources that hold or maintain accounts associated with the depositing party, such as a funded or credit account managed by a bank/credit union, credit card provider, or credit agencies. The output module 30 may communicate with, provide instructions for preparing financial instruments to effectuate the fund transfer, provide transfer instructions, and/or direct fund transfers to a receiver account from one or more fund transfer resources that prepare suitable financial instruments, e.g., post office, convenience stores, banks/credit unions, grocery stores, or retailers. For example, the digital platform 12 or output module 30 thereof may communicate instructions to a fund transfer resource. The instructions may specify transfer and/or deposit details the fund transfer resource is to follow to transfer the funds from the account of the depositing party for deposit in the receiver account.

In some embodiments, funding from a depositing party's account may include utilizing an electronic fund transfer platform to transfer funds. Electronic fund transfer platforms may be integrated with the digital platform 12 and/or operated by the facilitator or comprise a third party pay application such as Dwolla, Zelle, Apple Pay, Google Pay, PayPal, or Venmo. Electronic fund transfer platforms may also include bank/credit union, credit card, credit agency, or other fund transfer resources with available electronic fund transfer protocols.

Similarly, the fund transfer facilitation system 10 or output module 30 thereof may communicate with an electronic fund transfer platform that manages a funded or credit account of the depositing party to provide instructions the electronic fund transfer platform is to follow to transfer the funds from the account of the depositing party to the receiver account. In some instances, the electronic fund transfer platform may not directly manage a funded or credit account of the depositing party but may be granted transfer capabilities with respect to an account of the depositing party held by another fund transfer resource, such as a bank/credit union or credit card company, for example. The electronic fund transfer platform may follow the instructions to effectuate the transfer of funds from the account of the depositing party to the account of the receiving party.

In some embodiments, output module 30 may output instructions and transmit the instructions to a fund transfer resource that is to prepare the financial instrument on behalf of the depositing party. The depositing party may be instructed to pick up the financial instrument and deliver it to the facilitator or receiver for deposit in the receiver account, provide authorization for the financial instrument to be deposited in the receiver account, or may be instructed to deposit the financial instrument directly into the receiver account. In one configuration, the instructions instruct the fund transfer resource to deliver the financial instrument to the facilitator or receiving party for deposit in the receiver account or deposit the financial instrument directly into the receiver account.

In one configuration, the digital platform 12 may include a user account module 40 configured to maintain user accounts. User accounts may be available to transaction parties and/or associated parties. For example, user accounts may be provided to real estate agents, brokers, title companies, closing companies, attorneys, buyers, sellers, or other users. A user having a user account may access the digital platform 12, provide login details to the user account module 40, and log into their account to view owned or associated transactions in which the user is named as either a depositing parity, receiving party, or associated party, such as a real estate agent. Account holders may also initiate fund transfers by accessing the intake module 20. The portal 22 may be provided within or separate from a user account. In one embodiment, the portal 22 provides access to user accounts as well as the intake module 20 and/or output module 30. In some embodiments, receiving parties having user accounts may identify receiving accounts to be used when named as a receiving party. Associated parties such as real estate agents may view and track associated transactions. Users accessing their user account may view statuses of fund transfers in which they are associated. For example, when completing the workflow, a depositing party may identify parties to the transfer, such as a seller, and people or entities associated with the transacting parties, such as real estate agents, brokers, title companies, closing companies, attorneys. The digital platform 12 may post deposits and associated logs to user accounts associated with transactions and may further provide updates of the progress of the transfer, e.g., instructions received or output, transfer instrument received, transfer instrument deposited, or the like. Thus, a real estate agent associated with a transaction may access their user account to determine if a depositing party has received instructions or how the transfer has progressed. The user account module 40 may query the input module 20 and/or output module 30 for transactions for which instructions have been output post log information in associated user accounts. The output module 30 may output transaction logs to the user account module 40 for posting in accounts of parties associated with the transaction. Posting or providing logs may include transmitting a notification or posting the log or log details in a user account held by the receiving party or associated party. In some embodiments, the receiving party may update the log upon receipt of the transfer instrument and/or deposit thereof. The user account module 30 may further post the updated log information to accounts of the other parties associated with the transaction, such as real estate agents. In various embodiments, users may upload important dates such as contract dates and deadlines, closing information, sales contracts, and the like to track and schedule real estate transactions the user is involved with.

The fund transfer facilitation system 10 may include one or more verification features. For example, to prevent cyber fraud or other fraudulent acts such as spoofing or modifying the transfer instructions that may result in directing the depositing party to deposit funds in another account, the output module 30 may output instructions including a verification feature. For example, the wire instructions may be output with one or more pieces of missing or incomplete information required for the transfer. The verification feature may require the depositing party to call the facilitator/system administrator or receiving party to confirm the transaction request and receive the complete transfer instructions. For example, all or a portion of the account number for the receiver account may be absent in the output instructions, and the depositing party may be required to call the facilitator or receiving party to receive the complete account number.

According to various embodiments, the fund transfer facilitation system 10 provides depositing parties, such as buyers, secure wire information, while moving real estate agents completely out of the exposure loop. Furthermore, the receiving party, such as a title company, receives monies accompanied with details regarding the transaction so they are not hunting all over to try and find a transaction that matches that wire amount. The facilitator, which may also be the receiving party, has a log of all the fund transfer requests, and can see who did or did not use the fund transfer facilitation system 10 to facilitate the deposit. Additionally, as noted above, the system 10 may include verification features requiring the depositing party to obtain or confirm certain wire information. The system 10 may track such confirmations and update the transaction log. The receiving party may access the log to see if the depositing party confirmed the wire information. This information is helpful to the facilitator or receiving party if they later have to defend in court after cyber fraud loss. In various embodiments, operations described herein with respect to the fund transfer facilitation system 10, digital platform 12, intake module 20, output module 30, and/or user account module 40 may be configured to be performed automatically.

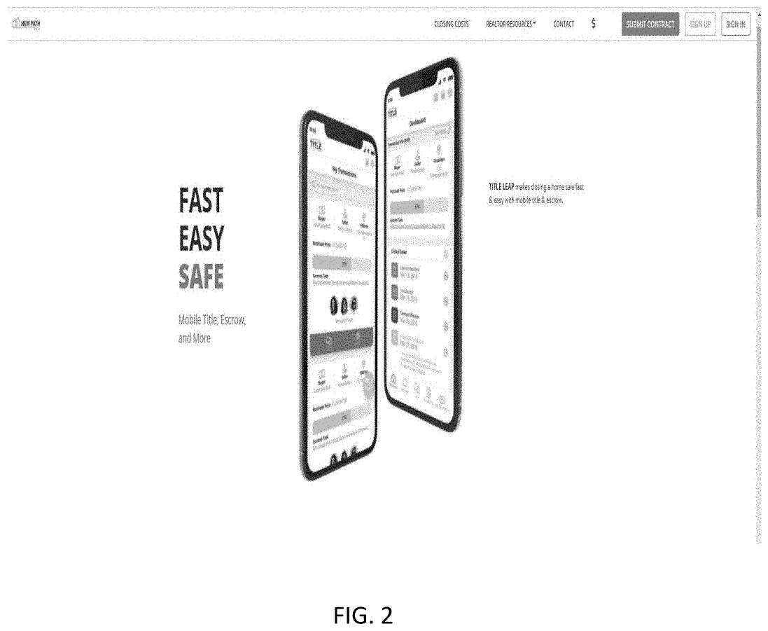

FIGS. 2-10 illustrate example operations of the fund transfer facilitation system according to various embodiments.

In one example, a real estate buyer may desire to deposit money with a title company for a new real estate contract utilizing the system. The fund transfer facilitation system may include a portal that may be selected by a party desiring to transfer money from their account to the title company account. A real estate agent for the buyer or seller or another party may instruct the buyer to enter the fund transfer facilitation system to facilitate the fund transfer. For example, the real estate agent may instruct the buyer to go to visit a website using an electronic device to access a portal and enter the workflow. FIG. 2 illustrates an example interface provided on a webpage that includes the portal to the intake module and associated workflow. The portal comprises a selectable money sign icon that the buyer, as the depositing party, may select to access the intake module and enter the workflow. The buyer may then follow the workflow to facilitate the transfer.

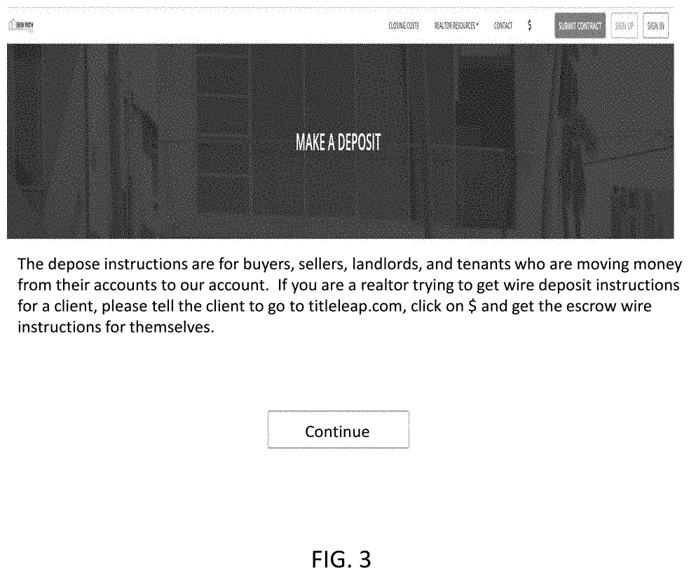

FIG. 3 illustrates an interface including an example notification page that may be presented to the depositing party or other party before or after entering the intake module. The notification page states that the deposit instructions output from the system are for buyers, sellers, landlords, and tenants who are moving money from their accounts to the receiver account. Thus, the faciliatory is also the receiver in this example. The notification also directs real estate agents that are trying to get wire deposit instructions for a client, to tell the client to access the system and select the portal to get wire instructions for themselves. This methodology takes the real estate agent out of the exposure loop.

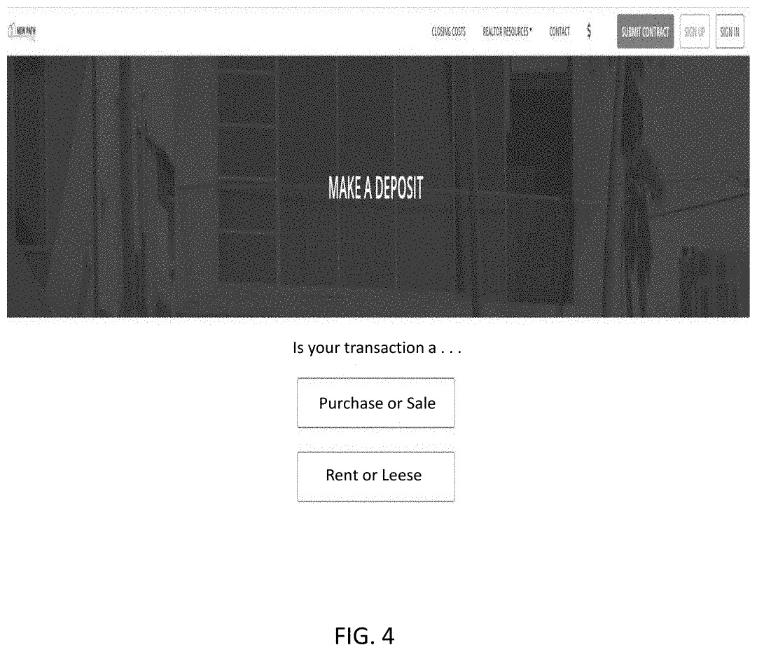

With reference to FIG. 4, within the workflow, the input module may query the depositing party to indicate the character of the transfer. For example, the user may indicate that the transaction relates to a purchase or sale or a rental or lease. The selection of the depositing party may be used to divide the workflow into the appropriate streams.

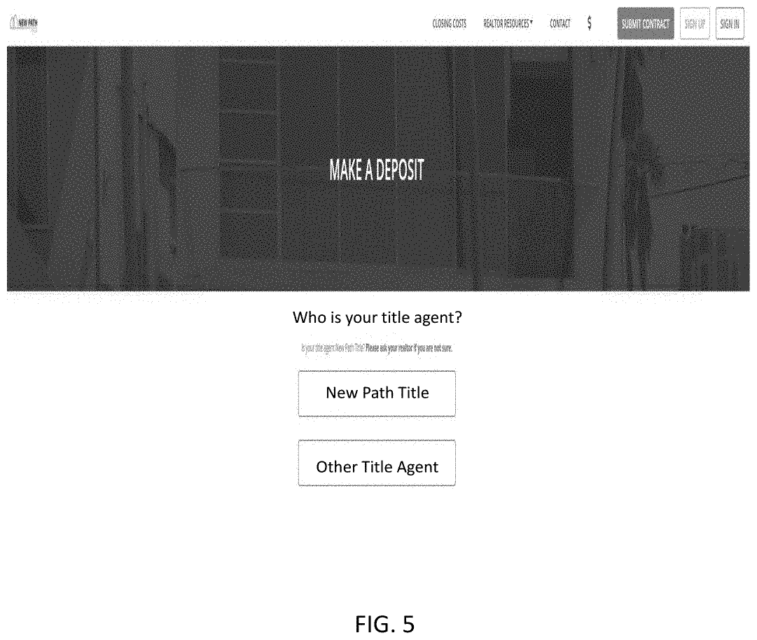

With reference to FIG. 5, if the depositing party indicates that the transaction relates to a purchase or sale, the depositing party may be asked to indicate the receiving party, such as a title company. In this example, the title company may be acting as the direct receiver of the fund transfer or may be operating as an intermediate for another title company and will provide wire or check instructions with respect to another title company. In some embodiments, if the depositing party selects “other title agent,” the workflow may generate a selectable list of title agents or companies available or otherwise prompt the depositing party to identify the title agent or other receiving party. In some embodiments, if the depositing party selects “rental or lease” (see FIG. 4), the workflow may similarly present a selectable list of receiving parties or otherwise prompt the depositing party to identify the receiving party.

Receiving parties may have a user account with the fund transfer facilitation system. The receiving parties may provide information regarding their receiver accounts that the fund transfer facilitation system may use to provide instructions to depositing parties desiring to deposit funds with the receiving party. The receiving party may specify multiple accounts and criteria for deposits into particular receiver accounts. For example, a receiver account may be used for certain types of escrow transactions which the receiving party identifies in the receiving party's user account. The fund transfer facilitation system may process depositing party requests through the workflow to determine the correct receiver account subject to the instructions as specified in the receiving party's user account. Thus, receiving parties may use their user accounts to quickly and easily specify or update receiver accounts, in real-time. Periodically changing receiver accounts may be used by receiving parties to combat potential fraud.

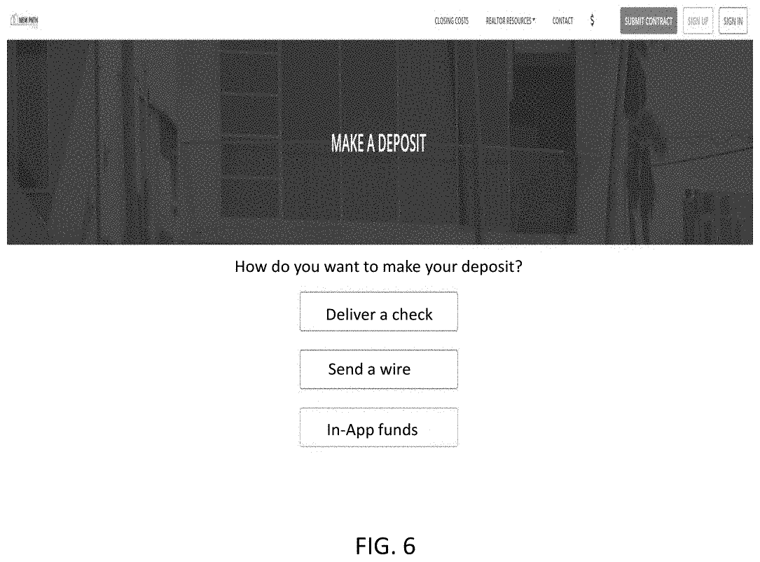

The workflow may include obtaining a desired method of transfer. For instance, the depositing party may be provided with options for depositing funds by check, money order, wire, or funding from an account, such as a bank account or funded account, which may include utilizing a fund transfer platform. With reference to FIG. 6, when the fund transfer facilitation system is set up to facilitate transfers via multiple selectable financial instruments, the workflow may query the depositing party for the type of financial instrument that will be the vehicle for the fund transfer. In the illustrated example, the intake module prompts the depositing party to select a desired financial instrument. It is to be appreciated that the various prompts may not be in the order presented and/or may not be provided in ordered prompts. For example, a depositing party may be prompted to indicate the transfer instrument before identifying a target title agent or may be requested to enter such information. In the illustrated example, the fund transfer facilitation system is configured to provide instructions for delivery of a check, wire transfer, and electronic fund transfer via a financial application platform.

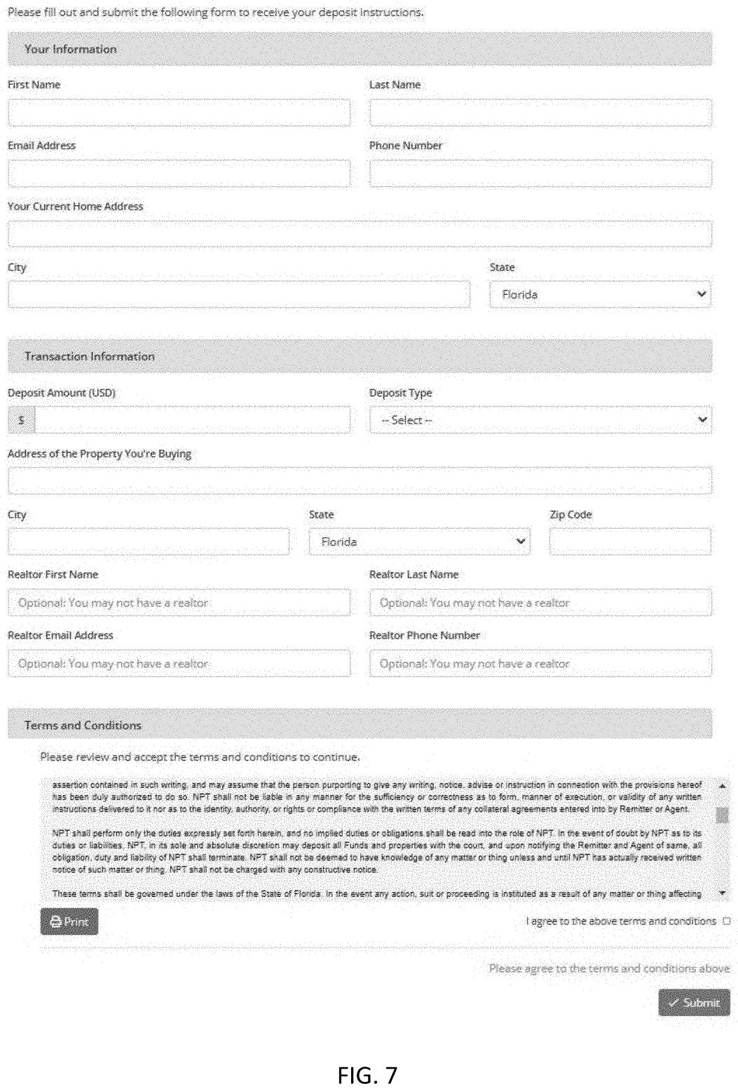

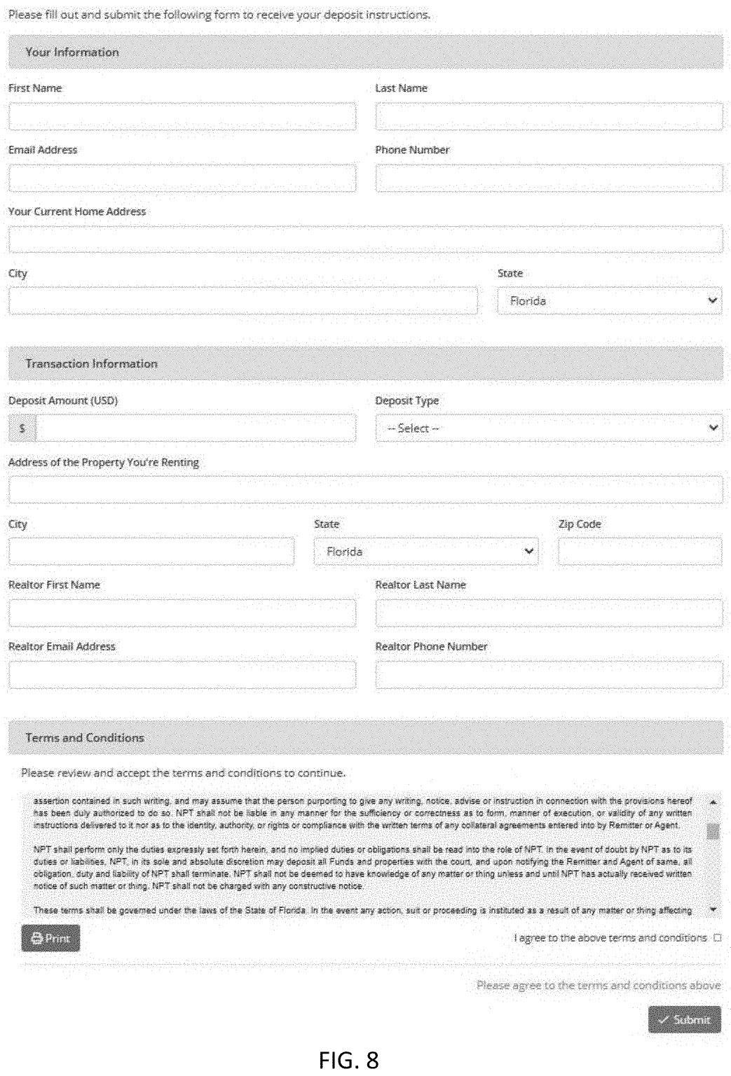

FIGS. 7 & 8 illustrate example data requests within the workflow of the intake module according to various embodiments. The data request forms obtain information from the depositing party regarding the desired transfer that the output module uses to generate custom instructions and/or transfers. The data request requests information about the depositing party, such as name, contact information (email, phone number), and current address. The data requests also requests information about the transaction, such as the amount, deposit type (e.g., first deposit, additional deposit, cash to close), address of the subject property (buying in FIG. 7, renting in FIG. 8), and realtor name and contact information (email, phone number).

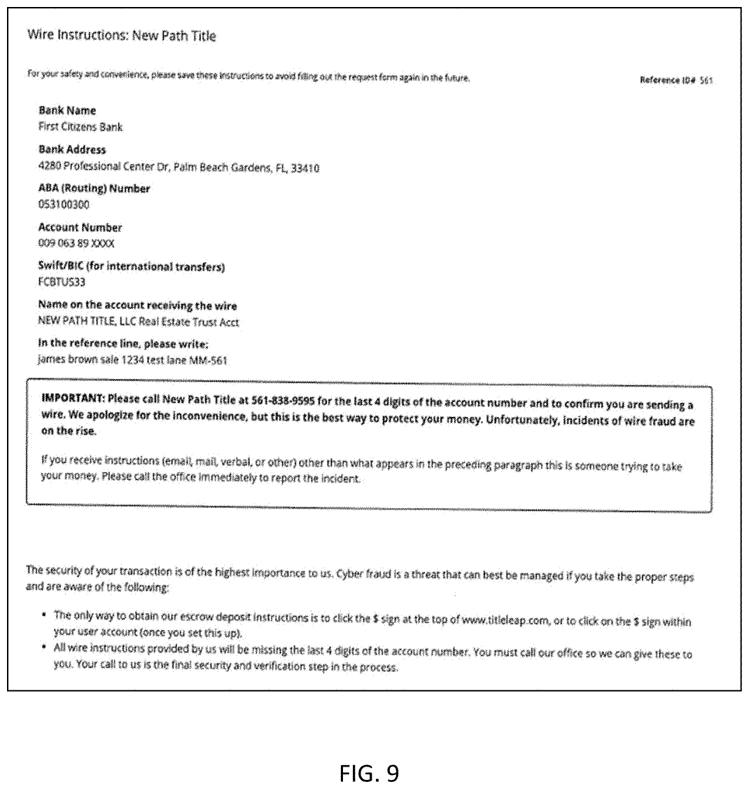

FIGS. 9 & 10 illustrate example output instructions generated by the output module according to various embodiments. The output instructions may specify account information with respect to the account the funds should be deposited. In one embodiment, the output instructions also include one or more notations to accompany the funds. For example, the output instructions may include instructions to include a particular code, contract reference, address of the subject property, reference to a sales contract, and/or reference to another party to the transaction, such as a real estate agent. The notation may accompany the funds by, for example, inclusion on the check, money order, wire transfer, direct fund transfer, or other transfer instrument. In some embodiments, the instructions may be provided to the depositing party to a bank or fund transfer platform, which may be in addition to or instead of outputting instructions to the depositing party. For example, the output instructions may include wire transfer instructions, check deposit instructions, or other fund transfer instructions. In one embodiment, the fund transfer instructions include instructions to be provided to a bank, fund transfer platform, or other account holder holding funds of the depositing party to be transferred to an account of the receiving party. In a further example, the output instructions are provided to a fund transfer platform or credit card company having an account of the depositing party.

With particular reference to FIG. 9, if the depositing party is to deposit funds via a wire transfer, the output module may provide the depositing party wire transfer instructions. The output instructions include the name and address of the bank maintaining the receiver account, ABA (routing) number, receiver account number, swift/BIC code, name on the receiver account, and notation to add to the reference line.

The instructions output with respect to the wire transfer instructions include a verification feature to address cyber fraud. In this example, obtaining wire instructions requires that the depositing party submit to a specific workflow, wherein deviations from the workflow are identified as being outside what the fund transfer facilitation system and faciliatory will ask of the depositing party. Therefore, deviations should be considered fraudulent attempts to undermine the process. In this instance, the path into the workflow for receiving custom wire transfer instructions is provided only through the portal available on the system website. The depositing party may enter the portal only by clicking on the $ sign at the top of the webpage, which may be provided on a home page or within the user account of the depositing party, if they have one. Additionally, the wire instructions may be output with one or more pieces of missing or incomplete information required for the transfer. The depositing party is required to call the facilitator as a final verification step to receive the missing information, which in this example are the last 4 digits of the receiver account number. In some embodiments, other elements of the transfer instructions may be absent or incomplete.

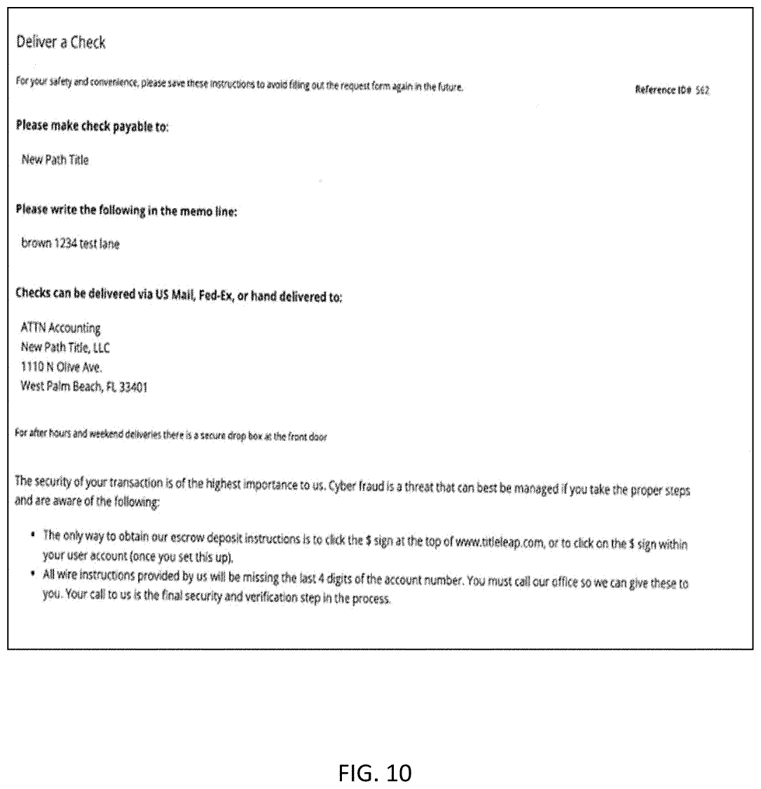

With reference to FIG. 10, if the depositing party is to deposit funds via a check or money order, the output module may provide the depositing party with custom check or money order deposit instructions. In some embodiments, verification steps may be provided with respect to check delivery instructions, which may be in a manner similar to that described with respect to wire transfer instructions.

As introduced above, some embodiments of the fund transfer facilitation system may facilitate electronic fund transfers. For example, if the depositing party is to deposit funds via a fund transfer platform or application, such as Dwolla, Zelle, Apple Pay, Google Pay, PayPal, or Venmo, the output module may output custom electronic fund transfer instructions or facilitate the transfer. The instructions may include the account information of the receiver account similar to the wire instructions. Verification steps may be provided in some configurations, which may be in a manner similar to that described with respect to wire transfer instructions. In one embodiment, the fund transfer facilitation system integrates with a fund transfer platform to electronically transfer money into receiver accounts. For example, during the intake phase the depositing party may key in their ABA (routing number), account number, and a deposit value and the output module may move the money right into the receiver account. If the depositing party has a standing user account, the depositing party may be provided with an identification code that the depositing party or the output module may associate with the deposit.

As indicated above, the output module may create a log of transaction instructions and associated outputs, verifications, transaction progress, deposits, or the like. The log information may be provided to receiving parties for matching deposits with requests and associated information, such as associated parties and subject property. User accounts maintained by the fund transfer facilitation system may include a dashboard or other interface listing one or more of pending deposits, deposits in progress, or deposits in which the account holder is named as a party (depositing party, receiving party) or associated party (real estate agent). The interface may provide information such as the date instructions were given to access the portal, deposit instructions were given, or other events related to the progress. Other information may be included such as links to a sales contract (which may be uploaded to the user account by a user), important dates with respect to the deposit or sale, such as a closing date. In some configurations, the interface may provide various data views such as viewing by property, transaction stage, progress within particular transaction stages, or by transaction dates (sales contract date, funding deadline, closing date, etc.). Thus, the system may catalog all transfer requests to a backside dashboard and make the logs available to appropriate user accounts. A title agency operating the system as a facilitator and receiving party may similarly track transaction requests and deposits.

The system avoids the problem of naked wires, which have always plagued title companies. The system allows receiving parties to organize incoming wires and deposits to assist with planning for current files and for future transfers. The system may also protect title companies by the title company by providing the deposit information and verifying receipt of the deposit information. Real estate agents are also protected by being removed from the liability loop.

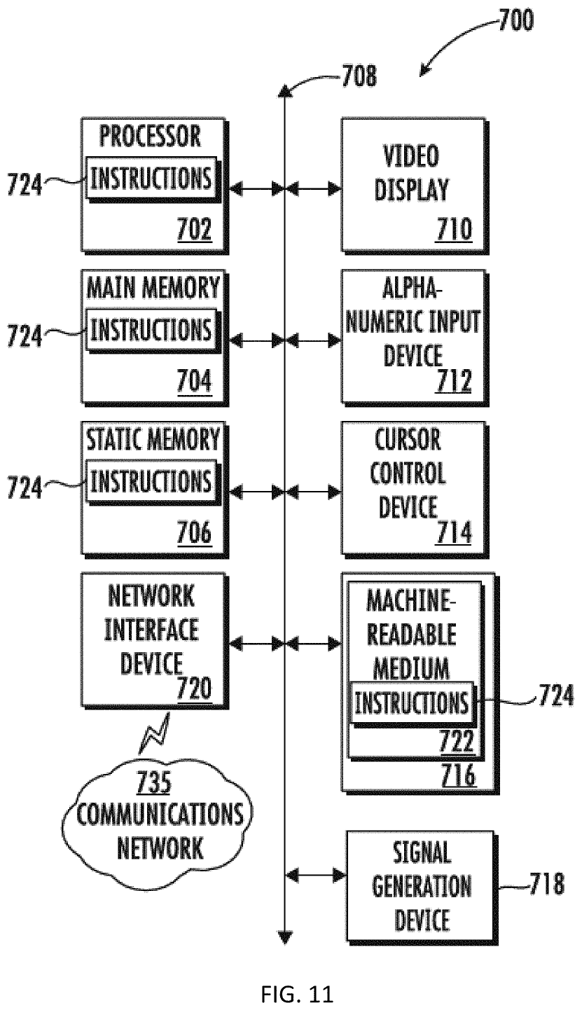

Referring to FIG. 11, at least a portion of the present invention may incorporate one or more computer apparatuses 700. Such a computer apparatus 700 may comprise a machine such as, but not limited to, a computer system, apparatus, or other arrangement of one or more computing devices within which a set of instructions 724, when executed, may cause the machine to perform any one or more of the methodologies or functions discussed above alone or in conjunction other one or more additional machines associated with the network or system, e.g., digital platform described herein, or another network or system. While a single machine 701 is illustrated in FIG. 11, the term “machine” shall also be taken to include any collection of machines that individually or jointly execute a set (or multiple sets) of instructions 724 to perform any one or more of the methodologies discussed herein. The machine may be configured to facilitate various operations conducted by the system. For example, the machine ay be configured to, but is not limited to, assist the network or system by providing processing power to assist with processing loads experienced in the network or system, by providing storage capacity for storing instructions 724 or data traversing the network system, or by assisting with any other operations conducted by or within the network or system.

In some embodiments, the computer apparatus 700 or a machine thereof may operate as a standalone device. In some embodiments, the computer apparatus 700 or a machine 701 thereof may be connected via a communication network 735 to and assist with operations performed by other apparatuses, machines, or systems. For example, the computer apparatus 700 or a machine 701 thereof may be connected with any component in the network or system. In a networked deployment, the computer apparatus 700 or a machine thereof may operate in the capacity of a server, server stack, or a client, such as a client user machine, in a server-client user network environment, or as a peer machine in a peer-to-peer (or distributed) network environment. The server may be a web server, application server, or the like. The computer apparatus 701 or a machine thereof may comprise a server computer, a client user computer, a personal computer (PC), a tablet PC, a laptop computer, a desktop computer, a control system, a network router, switch or bridge, or any machine capable of executing a set of instructions 724 (sequential or otherwise) that specify actions to be taken by that computer apparatus 700 or a machine 701 thereof. In one example, the computer apparatus 700 comprising one or more machines 701 is arranged to have a distributed architecture employing a suitable model such as a client-server model. In one embodiment, the computer apparatus 700 may include a web service, e.g., service oriented architecture (SOA) or simple object access protocol (SOAP). The computer apparatus 700 may include a software as a service (SaaS) platform. The computer apparatus 700 may include representational state transfer style resources or resource oriented architecture (ROA). The computer apparatus 700 may include one or more processors, servers, databases, networks or network devices, and peripherals configured to obtain and transmit data and initiate operations configured to perform in whole or in part the operations of the system or platform thereof.

The computer apparatus 700 may include a processor 702, e.g., a central processing unit (CPU), and memory. Various arrangements of memory may be present. For example, a main memory 704 and a static memory 706, which communicate with each other via a bus 708, may be present. The computer apparatus 700 may further include a graphics processing unit (GPU). The computer apparatus 700 may include a video display unit 710, which may be, but is not limited to, a liquid crystal display (LCD), a flat panel, a solid state display, or a cathode ray tube (CRT). The computer apparatus 700 may include an input device 712, such as, but not limited to, a keyboard, a cursor control device 714, such as, but not limited to, a mouse, a disk drive unit 716, a signal generation device 718, such as, but not limited to, a speaker or remote control, and a network interface device 720.

The disk drive unit 716 may include a machine-readable medium 722 on which is stored one or more sets of instructions 724, such as, but not limited to, software embodying any one or more of the methodologies or functions described herein, including those methods illustrated above. For example, the digital platform described herein may be provided in a set of instructions on a machine-readable medium 722. The digital platform may be executed on a server or application server. Network device may access the digital platform via a network connection at one or more communication ports. The instructions 724 may also reside, completely or at least partially, within the main memory 704, the static memory 706, or within the processor 702, or a combination thereof, during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the processes described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example network or system is applicable to software, firmware, and hardware implementations.

In accordance with various embodiments of the present disclosure, the processes described herein are intended for operation as software programs running on a computer processor. Furthermore, software implementations can include, but are not limited to, distributed processing or component/object distributed processing, parallel processing, or virtual machine processing that may be constructed to implement the methods described herein.

The present disclosure describes various modules, which may also be referred to as sub-modules, portals, generators, engines, systems, subsystems, components, units, and the like. Such modules may include functionally related hardware, instructions, firmware, or software. Modules may include physical or logical grouping of functionally related applications, services, resources, assets, systems, programs, databases, or the like. Modules or hardware storing instructions configured to execute functionalities of the modules may be physically located in one or more physical locations. For example, modules may be distributed across one or more networks, systems, devices, or combination thereof. It will be appreciated that the various functionalities of these features may be modular, distributed, and/or integrated over one or more physical devices. For example, all or portions of the databases may reside or be distributed among one or more hardware locations.

The present disclosure contemplates a machine-readable medium 722 containing instructions 724 so that a device connected to the communications network 735, another network, or a combination thereof, can send or receive data, which may include voice, video, text, code, or other data, and to communicate over the communications network 735, another network, or a combination thereof, using the instructions. The instructions 724 may further be transmitted or received over the communications network 735, another network, or a combination thereof, via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of the network architecture, systems, and processes that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A real estate fund transfer facilitation system, the system comprising:
a digital platform for receiving a request to facilitate a real estate fund deposit from a depositing party to a receiving party comprising a title company or title agent, the digital platform comprising:
an intake module configured to marshal the depositing party through a workflow to collect transaction information, and define a transfer of the funds for deposit in a receiver account of the receiving party using at least a portion of the collected transaction information;
a portal comprising a selectable link for accessing the intake module; and
an output module for outputting transaction instructions with respect to preparation of a financial instrument as a vehicle for the transfer of the real estate funds in the receiver account.

2. The system of claim 1, wherein the output instructions include one or more absent or incomplete pieces of information, and wherein the depositing party is required to call a system administrator or the receiving party to obtain the absent or complete information.

3. The system of claim 2, wherein the one or more absent or incomplete pieces of information comprises an account number for the receiver account.

4. The system of claim 1, wherein the financial instrument is a wire transfer and the transaction instructions include a notation to be included in a reference line associated with the wire transfer.

5. The system of claim 4, wherein the notation includes an address of the subject property or a reference to a sales contract.

6. The system of claim 1, wherein the portal comprise a selectable link.

7. The system of claim 6, wherein selecting the selectable link for the portal is the only way a depositing party may access the intake module.

8. The system of claim 1, wherein the intake module queries the depositing party for a type of financial instrument for which the depositing party is requesting the output module to output instructions.

9. The system of claim 1, wherein the transaction information includes a name of a real estate agent associated with the transaction.

10. The system of claim 1, wherein the transaction information includes an address of a subject real estate property.

11. The system of claim 1, further comprising a user account module configured to maintain user accounts for parties associated with the transaction.

17. The system of claim 11, wherein, when the output module outputs transaction instructions, the output module posts a transaction log to user accounts of the parties associated with the transaction selected from a real estate agent or the receiving party.

13. A method of facilitating real estate fund transfer, the method comprising:
receiving a request to facilitate a real estate fund deposit from a depositing party to a receiving party comprising a title company or title agent;
marshaling the depositing party through a workflow to collect transaction information and define a transfer of the funds for deposit in a receiver account of the receiving party using at least a portion of the collected transaction information;
providing a selectable link to the workflow; and
outputting transaction instructions with respect to preparation of a financial instrument as a vehicle for the transfer of the real estate funds in the receiver account.

14. The method of claim 13, wherein the output instructions include one or more absent or incomplete pieces of information, and wherein the depositing party is required to call a system administrator or the receiving party to obtain the absent or complete information.

15. The method of claim 14, wherein the one or more absent or incomplete pieces of information comprises an account number for the receiver account.

16. The method of claim 13, wherein the financial instrument is a wire transfer and the transaction instructions include a notation to be included in a reference line associated with the wire transfer selected from an address of the subject property or a reference to a sales contract.

17. The method of claim 16, wherein selecting the selectable link for the portal is the only way a depositing party may access the intake module.

18. The method of claim 13, further comprising: maintaining user accounts for parties associated with the transaction; generating a transaction log with respect to transaction instructions output to depositing parties; and posting events related to the transaction to user accounts of parties associated with the transaction.

19. The method of claim 18, further comprising: receiving a transaction update that funds subject to the deposit have been deposited in the receiver account; and posting the update in user accounts of parties associated with the transaction.
